(19) United States
(12) Patent Application Publication
(10) Pub. No.: US 2014/0300702 A1
(43) Pub. Date: Oct. 9, 2014

(54) Systems and Methods for 3D Photorealistic Automated Modeling

(71) Applicants: Tagir Saydkhuzhin, Miami, FL (US); Konstantin Popov, Moscow (RU); Michael Raveney, Miami, FL (US)

(72) Inventors: Tagir Saydkhuzhin, Miami, FL (US); Konstantin Popov, Moscow (RU); Michael Raveney, Miami, FL (US)

(21) Appl. No.: 14/213,414

(22) Filed: Mar. 14, 2014

Related U.S. Application Data
(60) Provisional application No. 61/793,095, filed on Mar. 15, 2013.

(51) Int. Cl. H04N 13/02; G06T 17/00

(52) U.S. Cl. CPC H04N 13/0275; G06T 17/00
USPC 348/47

(57) ABSTRACT

Systems and methods for creating a 3D photorealistic model of a real-life object by applying a combined solution based on the analysis of photographic images combined with use of the data obtained from depth sensors, which are able to read the depth of and, thereby create maps of, the area sensed. Data arrives from two types of devices and is compared and combined. The developed matching algorithm captures the data and automatically creates a photorealistic 3D model of an object without the need for further manual processing. From this, photorealistic quality 3D models are created by building a polygon mesh and creating sets of textures, using the data coming from these two device types. The depth sensors make it possible to perform calculations of the depth maps generated from the real surrounding space of the object sensed.

### CROSS-REFERENCE TO RELATED APPLICATIONS

This application claims the priority, under 35 U.S.C. §119, of U.S. Provisional Patent Application Ser. No. 61/793,095, filed on Mar. 15, 2013, the entire disclosure of which is hereby incorporated by reference in its entirety.

### STATEMENT REGARDING FEDERALLY SPONSORED RESEARCH OR DEVELOPMENT

Not Applicable

### FIELD OF THE INVENTION

The present invention lies in the field of computer modeling. The present disclosure relates to systems and processes for modeling in 3D actual people or actual things from high-resolution photographic images of that person or object.

### BACKGROUND OF THE INVENTION

Currently, in video games and other three-dimensional (3D) programs, avatars (not real-life objects) are created. 3D software engines are used to make those people or things move, such as making an avatar of a person run. There exists no 3D modeling of actual people or actual things that is created from high-resolution photographic images.

Thus, a need exists to overcome the problems with the prior art systems, designs, and processes as discussed above.

### SUMMARY OF THE INVENTION

The invention relates to a new way to make a 3D computer-generated imagery (CGI) model of an object from cameras and sensors. The system includes a set of cameras and depth sensors at various angles to an object to be 3D modeled. Lights are organized in a way so that none of the cameras are “blinded.” Pictures are taken from many angles. Examples of a subject to be 3D-modeled can be a person or a product. The systems and processes of the present invention actually transcend the simulated avatar by utilizing high-quality photographs from around the object or person and, instead of creating an unreal avatar, creates a photo-realistic object that can be viewed from all sides. In this way, for example, instead of having an avatar of a basketball player play a basketball video game, high resolution images of the real basketball player are taken from all sides and then are converted into a 3D likeness that can be made to play basketball and look as if the actual player was playing.

The systems and methods described create the 3D models by applying a combined solution based on the analysis of photographic images combined with use of the data obtained from depth sensors, which are able to read the depth of and, thereby create maps of, the area sensed. Data arrives from two types of devices and is compared and combined.

The developed matching algorithm captures the data and automatically creates a photorealistic 3D model of an object without the need for further manual processing. From this, photorealistic quality 3D models can be created by building a polygon mesh and creating sets of textures, using the data coming from these two device types. The depth sensors make it possible to perform calculations of the depth maps generated from the real surrounding space of the object sensed.

A unique algorithm of matching composite received data is provided and allows for the automatic reconstruction of a photorealistic 3D-model of the object without the need for further manual adjustments.

The invention provides systems and methods for 3D photorealistic automated modeling that overcome the hereinafore-mentioned disadvantages of the heretofore-known devices and methods of this general type and that provide such features with photorealism without manual processing.

With the foregoing and other objects in view, there is provided systems for creating a three-dimensional photorealistic model of a real-life object, comprising a set of high-resolution photographic cameras positioned about the object at multiple angles to take photographic images of the entirety of the object, a set of depth sensors positioned about the object to scan an area in which the object is disposed and to generate depth map data of the scanned area, wherein each depth sensor is aligned with one of the photographic cameras, a computer modeling system communicatively coupled to the set of photographic cameras and the set of depth sensors, and wherein the set of photographic cameras and the set of depth sensors transmit photographic image data and depth map data to the computer modeling system and, using at least one computer-executed algorithm, the computer modeling system processes the transmitted photographic image and depth map data and automatically creates a photorealistic three-dimensional computer model of the object.

With the foregoing and other objects in view, there is further provided methods for creating a three-dimensional photorealistic model of a real-life object, comprising positioning a set of high-resolution photographic cameras about the object at multiple angles to take photographic images of the entirety of the object, positioning a set of depth sensors about the object to scan an area in which the object is disposed, wherein each depth sensor is aligned with one of the photographic cameras, communicatively coupling a computer modeling system to the set of photographic cameras and to the set of depth sensors, capturing photographic image data of the object using the set of photographic cameras and transmitting the captured photographic image data to the computer modeling system, scanning the area in which the object is disposed using the set of depth sensors and transmitting generated depth map data to the computer modeling system, and using at least one computer-executed algorithm, processing the transmitted photographic image and depth map data and automatically creating a photorealistic three-dimensional computer model of the object with the computer modeling system.

Although the invention is illustrated and described herein as embodied in systems and methods for 3D photorealistic automated modeling, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a perspective view of an exemplary embodiment of a scanning pavilion;

FIG. 2 is a block circuit diagram of an exemplary embodiment of a computer modeling system;

FIG. 3 is a block circuit diagram of another exemplary embodiment of a computer modeling system;

FIG. 4 is a flow chart of an exemplary embodiment of a computer modeling method;

FIG. 5 is a flow chart of an exemplary embodiment of a preparation phase of a method for carrying out the 3D modeling;

FIG. 6 depicts an exemplary embodiment of a calibration process of a method for carrying out the 3D modeling;

FIG. 7 is a flow chart of an exemplary embodiment of a data capture phase of a method for carrying out the 3D modeling; and

FIG. 8 is a flow chart of an exemplary embodiment of a processing phase of a method for carrying out the 3D modeling.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

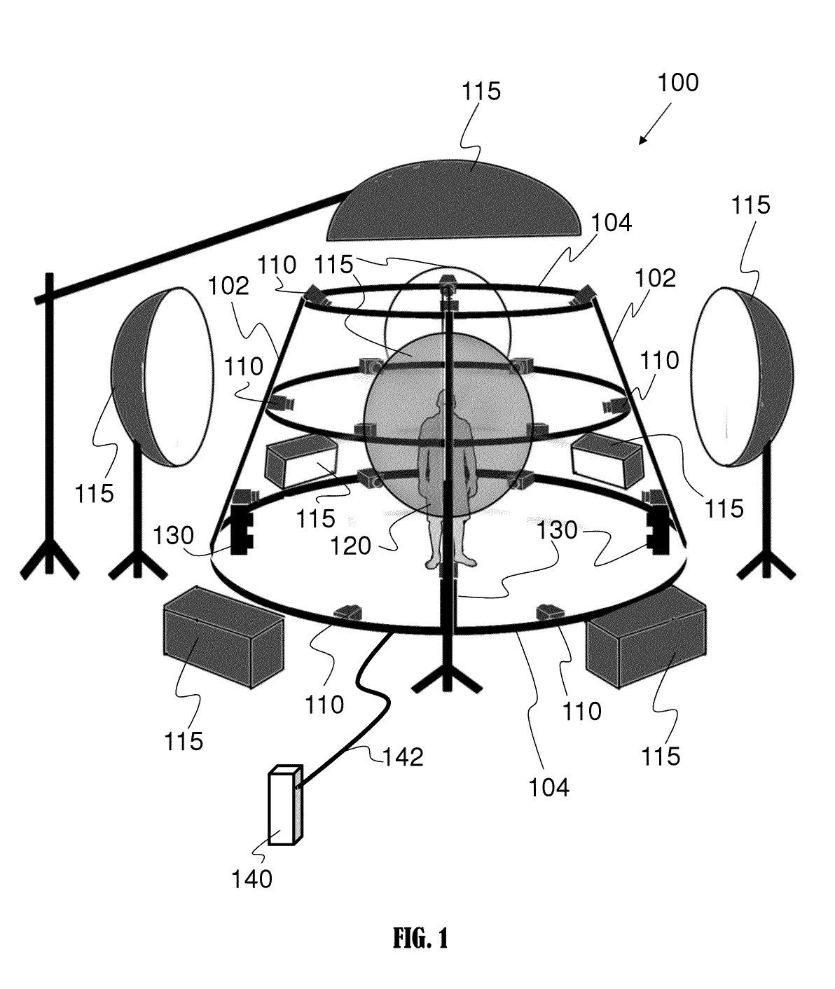

Described now are exemplary embodiments of the present invention. Referring now to the figures of the drawings in detail and first, particularly to FIG. 1, there is shown a first exemplary embodiment of a scanning pavilion 100 for use with the systems and methods for 3D photorealistic automated modeling. The scanning pavilion 100 is formed by a solid structure having vertical supports 102 connected to horizontal supports 104. The shape of the supports 102, 104 are selected as shown in FIG. 1 so that a set of “N” number of high-resolution cameras 110 can be positioned at many locations surrounding a real-life object 120 to be photographed and 3D modeled, whereby the number “N” can be any integer number of 1 or greater.

The configuration and/or number of these supports 102, 104 shown is merely exemplary and can take any shape or form that provides the functions described herein. For example, they can be entirely absent and replaced by individual stands or individual hanging cables that place the cameras 110 at the various positions around, at, above, and below the object 120 and can take different shapes and sizes depending upon the application.

The cameras 110 are networked together to take pictures virtually simultaneously but not adversely affecting others of the cameras 110 when a particular picture is being taken. Significantly, the cameras 110 are set around, below, at and above the object 120 so that they can see the entirety of the object 120. The configuration and/or numbers of the cameras 110 shown in FIG. 1 are merely exemplary and the number of cameras can be greater or less and the positions can be lower or higher or displaced.

Lights 115 are also organized at, above, around, and below the object 120 so that none of the cameras are “blinded.” These lights 115 can also be mounted on the scanning pavilion 100 at locations between sets of cameras 110, for example.

Also provided is a set of “M” number of depth sensors 130 around the object 120, whereby the number “M” can be any integer number of 1 or greater. The depth sensors 130 are able to scan the depth of points of the object 120 and, thereby create depth maps of the area sensed. The depth sensors 130 make it possible to perform calculations with the depth maps generated from the real surrounding space of the sensed object 120. One exemplary embodiment for the depth sensors 130 is similar to the sensors used by the Kinect® device of the Xbox® gaming system by Microsoft®.

To start a 3D scan of the object 120, the cameras 110 take pictures from all of the various angles with the lights 115 at the same or similar illumination (e.g., intensity and color) from all sides of the object 120. In this way, there are no shadows and the photographs around the object 120 will have the same “look.” At the same time, the depth sensors 130 scan the object 120 and create a depth map.

A computer modeling system 140 (for example, including a computer, a multi-computer system, a server, or a multi-server system) applies a combined software solution based on the analysis of the photographic images and depth map data taken. This data arrives from the cameras 110 and depth sensors 130 (either through cabling 142 or wirelessly) and is compared and combined. The data input from the high-resolution cameras 110 is in the form of one or more images. The data input from the depth sensors 130 is, for example, in the form of one or more lower-resolution color images in RGB24 format and information about the distance from the depth sensor 130 to the object 120 (hereinafter referred to as a “depth map”) in 12 bits per pixel format. Due to the design of the depth sensor 130, the color image and the depth map are taken from different positions. As described in further detail below, the cameras 110 and the depth sensors 130 are calibrated such that information about the optical settings and spatial position of the cameras is also used as data input into the modeling system 140. A matching algorithm automatically captures the data and automatically recreates a photorealistic 3D model of the object 120 without the need for manual processing. The computer modeling system creates photorealistic, high-quality 3D models by building a polygon mesh and creating sets of textures, using the data coming from these two devices 110, 130.

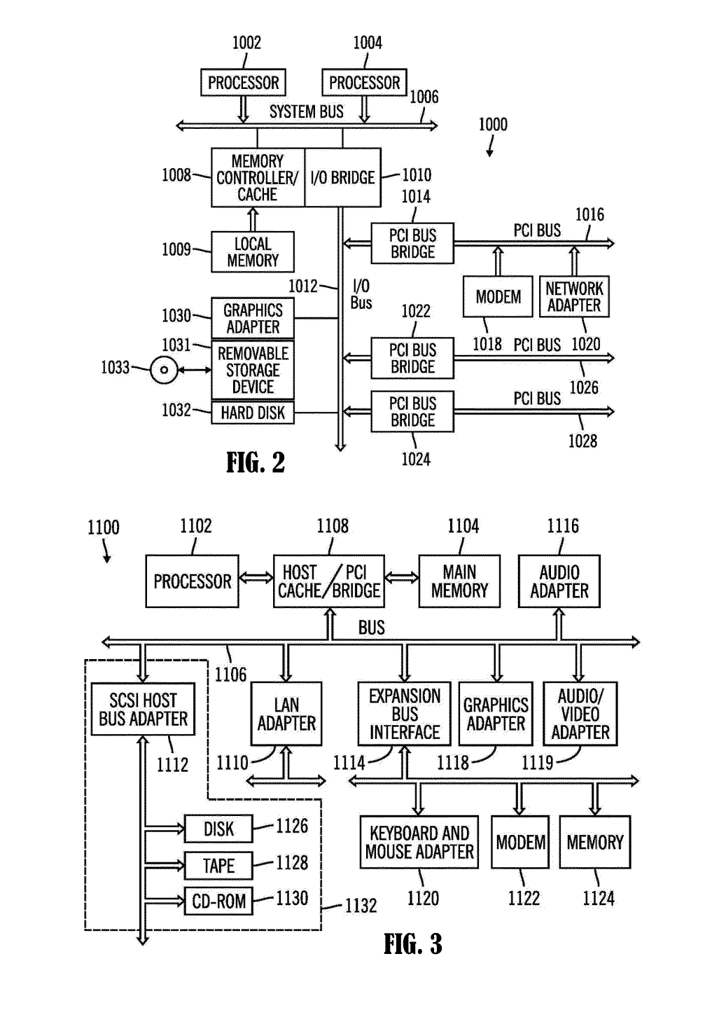

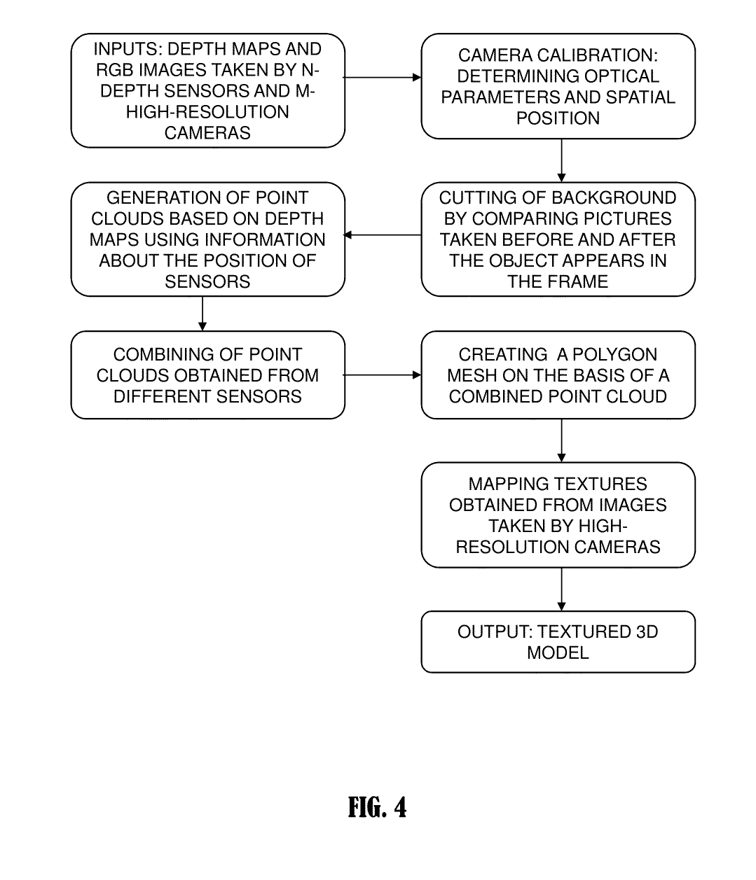

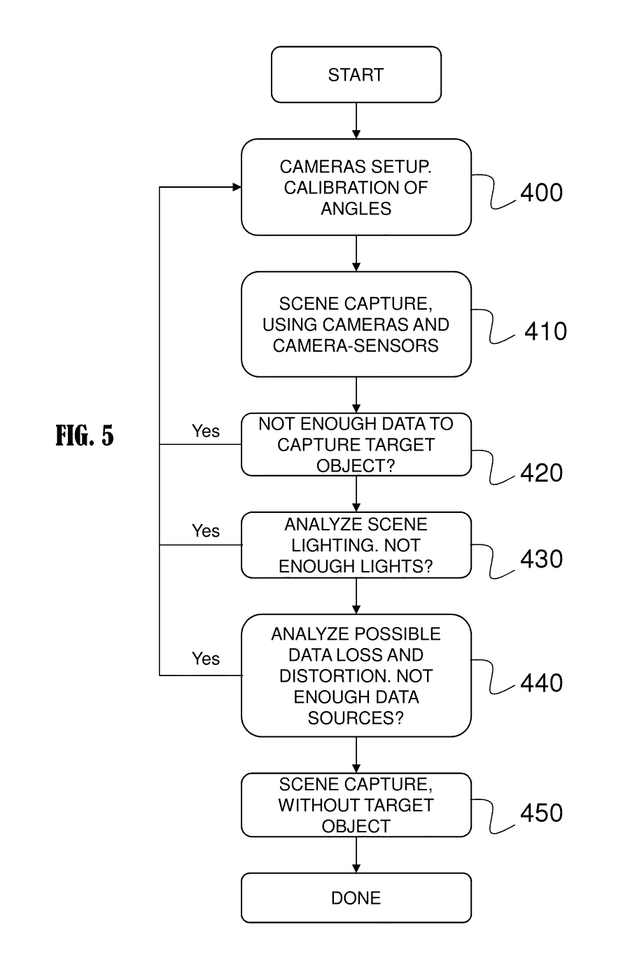

An example of the computer modeling system 140 is described with regard to FIGS. 2 and 3.

Server

FIG. 2 is a block diagram of the computer modeling system 140 that may be implemented as a server. Data processing system 1000 may be a symmetric multiprocessor (SMP) system including a plurality of processors 1002 and 1004 connected to system bus 1006. Alternatively, a single processor system may be employed. Also, connected to system bus 1006 is memory controller/cache 1008, which provides an interface to local memory 1009. I/O bus bridge 1010 is connected to system bus 1006 and provides an interface to I/O bus 1012. Memory controller/cache 1008 and I/O bus bridge 1010 may be integrated as depicted. The processor 1002 or 1004 in conjunction with memory controller 1008 controls what data is stored in memory 1009. The processor 1002 or 1004 can also work in conjunction with any other memory device or storage locations, such as storage areas, to serve as a monitor for monitoring data being stored and/or accessed on the data storage areas.

Peripheral component interconnect (PCI) bus bridge 1014 connected to I/O bus 1012 provides an interface to PCI local bus 1016. A number of modems may be connected to PCI bus 1016. Typical PCI bus implementations will support four PCI expansion slots or add-in connectors. Communications links to network computers may be provided through modem 1018 and network adapter 1020 connected to PCI local bus 1016 through add-in boards.

Additional PCI bus bridges 1022 and 1024 provide interfaces for additional PCI buses 1026 and 1028, from which additional modems or network adapters may be supported. In this manner, data processing system 1000 allows connections to multiple network computers. A memory-mapped graphics adapter 1030 and hard disk 1032 may also be connected to I/O bus 1012 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the computer modeling system 140.

In this document, the terms “computer program medium,” “computer usable medium,” and “computer readable medium” are used to generally refer to media such as main memory 1009, removable storage drive 1031, removable media 1033, hard disk 1032, and signals. These computer program products are measures for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may include computer readable information in a transitory state medium such as a network link and/or a network interface, including a wired network or a wireless network, that allow a computer to read such computer readable information.

Computer programs (also called computer control logic) are stored in memory. Computer programs may also be received through a communications interface 1016. Such computer programs, when executed, enable the computer system to perform the features of the computer modeling system 140 as discussed herein. In particular, the computer programs, when executed, enable the processor 1002 and/or 1004 to perform the features of the computer modeling system 140. Accordingly, such computer programs represent controllers of the computer modeling system 140.

Client Device

With reference now to FIG. 3, a block diagram illustrating a data processing system is depicted in which the computer modeling system 140 may be implemented. Data processing system 1100 is an example of a client computer 104. Data processing system 1100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 1102 and main memory 1104 are connected to PCI local bus 1106 through PCI bridge 1108. PCI bridge 1108 also may include an integrated memory controller and cache memory for processor 1102. Additional connections to PCI local bus 1106 may be made through direct component interconnection or through add-in boards. In the depicted example, local area network (LAN) adapter 1110, SCSI host bus adapter 1112, and expansion bus interface 1114 are connected to PCI local bus 1106 by direct component connection. In contrast, audio adapter 1116, graphics adapter 1118, and audio/video adapter 1119 are connected to PCI local bus 1106 by add-in boards inserted into expansion slots. Expansion bus interface 1114 provides a connection for a keyboard and mouse adapter 1120, modem 1122, and additional memory 1124, for example. Small computer system interface (SCSI) host bus adapter 1112 provides a connection for hard disk drive 1126, tape drive 1128, and CD-ROM drive 1130, for example. Typical PCI local bus implementations will support three or four PCI expansion slots or add-in connectors.

An operating system runs on processor 1102 and is used to coordinate and provide control of various components within data processing system 1100 in FIG. 3. Each client is able to execute a different operating system. The operating system may be a commercially available operating system, such as WINDOWS XP® or WINDOWS 7® which are available from Microsoft Corporation. A database program such as ORACLE® may run in conjunction with the operating system and provide calls to the operating system from JAVA® programs or applications executing on data processing system 1100. Instructions for the operating system, the object-oriented operating system, and applications or programs are located on storage devices, such as hard disk drive 1126, and may be loaded into main memory 1104 for execution by processor 1102.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes described herein may be applied to a multiprocessor data processing system.

As another example, data processing system 1100 may be a stand-alone system configured to be bootable without relying on some type of network communication interface, whether or not data processing system 1100 includes some type of network communication interface. As a further example, data processing system 1100 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 1100 also may be a notebook computer or hand-held computer in addition to taking the form of a PDA. Data processing system 1100 also may be a kiosk or a Web appliance.

The method for creating the 3D modeling has three phases—a preparation phase, a data capture phase, and a processing phase. Each are described in turn.

Preparation Phase

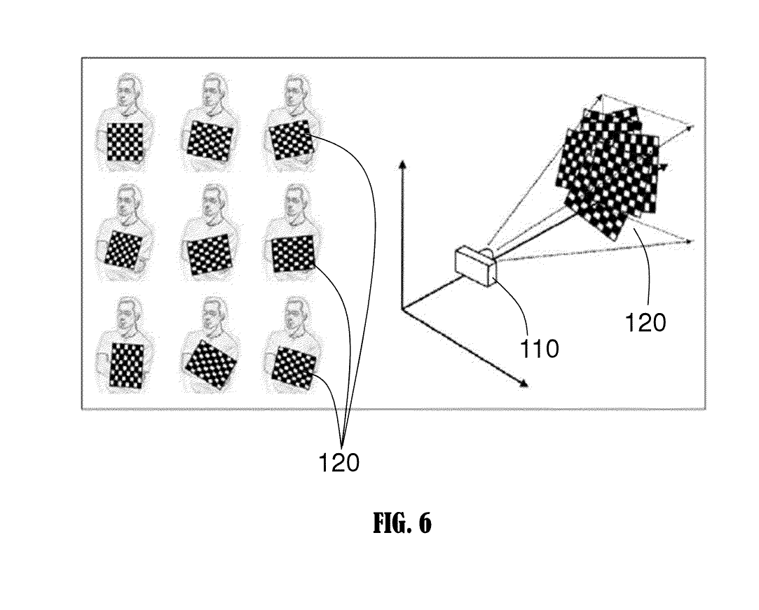

An exemplary embodiment of the 3D modeling method first involves the use of information received from the stand alone cameras 110 and the depth sensors 130 that are aligned or combined with the cameras 110 (hereinafter referred to as the “camera-sensors 110, 130”). The selected object 120 is placed in the center of the semi-spherical scanning pavilion 100. The camera-sensors 110, 130 are mounted at a distance of, for example, 4 to 10 meters from the center of the scanning pavilion 100. This phase can be explained with reference to FIG. 5, in which the setup starts and, at Step 400, the camera-sensors 110, 130 are installed and calibrated.

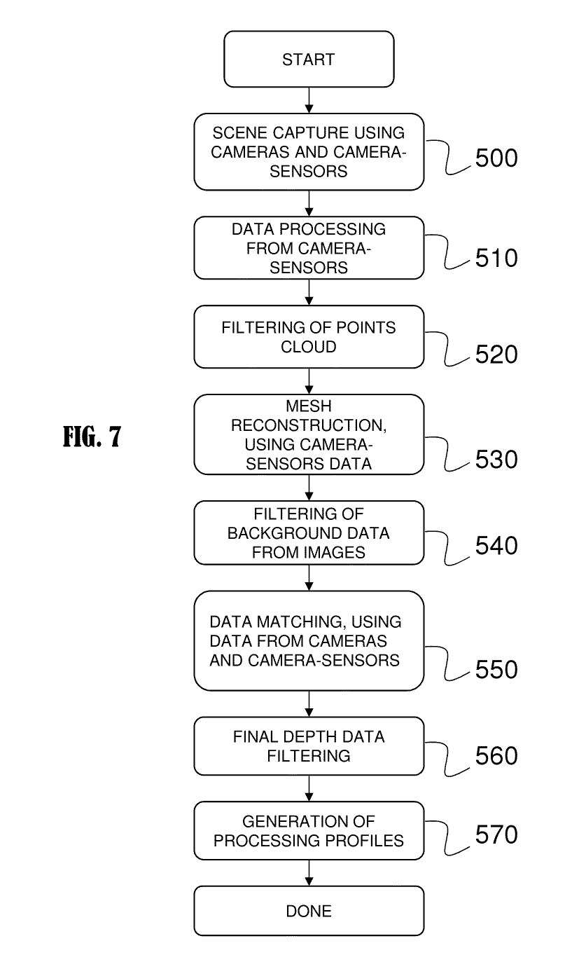

Shown in FIG. 6 is an exemplary embodiment of a calibration process in accordance with the invention. The calibration process is intended to establish the relative spatial positions, parameters, and angles of each of the camera-sensors 110, 130 such that the data received from each of the camera-sensors 110, 130 can later be combined to form the 3D model. In this particular embodiment, the camera-sensors 110, 130 are calibrated using a “checkerboard” as the object 120. The alternating black and white squares of the checkerboard object 120 ensure that there is no bias to one side or another when taking measurements. Using one or more computer-executed algorithms, the internal settings of each camera-sensor 110, 130 are calculated. The checkerboard object 120 is rotated and moved in order to obtain multiple views. The image of the checkerboard object 120 (or a person holding the checkerboard, or any other scene with the checkerboard and a sufficiently uncluttered background) can be used in order to find the angles of the checkerboard object 120. By analyzing a camera image from different angles, the relative location and orientation of the camera can be calculated when each image is taken. In accordance with the exemplary embodiment, an algorithmic function takes one image containing the checkerboard object 120 as an argument. This image is an 8-bit grayscale (single channel) image. The second argument shows the number of angles in each row and column on the board. It counts the number of internal angles. The next argument, angles, represents an indicator of the array that can record the locations of angles. Individual values represent the locations of angles as pixel coordinates. The last argument can be used to implement one or more additional filtering steps to help find angles on the checkerboard. In this particular embodiment of the calibration process, the camera-sensors 110, 130 are calibrated in pairs. A separate calibration is performed for each camera-sensor 110, 130 in order to obtain its actual optical settings before each pair of camera-sensors 110, 130 is calibrated. Afterwards, the first pair is chosen, then the second (where one camera includes a camera from the first pair), etc. Thus, if, for example, eight camera-sensors 110, 130 are being used, the calibration would be conducted in the following pairs: cameras 1 and 2, cameras 2 and 3, cameras 3 and 4, cameras 4 and 5, cameras 5 and 6, cameras 6 and 7, and cameras 7 and 8.

Referring back to FIG. 5, once the calibration process is complete, the camera-sensors 110, 130 perform a test scan and capture the surrounding space in Step 410. The data captured is analyzed. If there is enough data to capture the entire object 120 in Step 420, then the process proceeds to Step 430, otherwise, the process returns to Step 400 with an adjustment of the distance, for example. The scene illumination from the captured images is analyzed in step 430 by using the method of sensory geometry draft application. If the scene was lit properly, then the process continues to Step 440. If not, the lights 115 are adjusted and the process starts over from Step 400. In Step 440, the process analyzes possible distortions and the possibility of adjusting the data at the time of capture and determines if the distortion level is within an acceptable limit. If yes, then the process continues to the next stage described with regard to FIG. 7. If not, the camera position is adjusted to the required distance from the center of the pavilion 100 and the process starts over from Step 400. In Step 450, the surrounding space is captured with the cameras 110 without the object 120 (i.e., a blank template capture). This is used later for removing the structure of the pavilion 100, the cameras 110, the lights 115, and the depth sensors 130 from all of the photographs. Here, the camera-sensors 110, 130 scan the distance to the object to check the accuracy of their placement and the volume covered. Evaluation of the uncovered areas and synchronization of the cameras involved in the capture is communicated through a data protocol. After the entire area of the object 120 is captured, the process proceeds to the data capture phase.

Data Capture Phase

Referring to FIG. 7, the data capture phase begins. The accuracy of the preparation phase helps minimize and/or eliminate errors in synchronization of the photographs and the depth maps. The inventive method was developed by using matching algorithms of the processing of the data obtained from the cameras 110 with the data obtained from the depth sensors 130. In the data capture phase, the camera-sensors 110, 130 begin scanning in Step 500. Data processing occurs in Step 510. The camera capture is synchronized, one synchronized session being equal to one set of data from each of the cameras 110. Also, the “point cloud” received from each depth sensor 130 is analyzed. To generate a point cloud, according to an exemplary embodiment of the modeling method, a set of points is generated in three dimensions according to the captured depth map. Each point in the three-dimensional space of the depth map that belongs to the object of interest is assigned three coordinates that correspond to its pixel location. For example, according to an exemplary embodiment of the invention, each point is assigned the three coordinates, x, y, and z, where the formulas for each coordinate are:

$$x = dpth [ u , v ] * \frac{u - {cent}_{x}}{{f}_{x}}$$

$$y = dpth [ u , v ] * \frac{v - {cent}_{y}}{{f}_{y}}$$

$$z = dpth [ u , v ]$$

in which centₓ, cent_{y} is the optical center and fₓ, f_{y} is the focal distance.

Processing of the point cloud from each camera-sensor 110, 130 through filters is carried out in Step 520. The best set of data obtained from the cameras 110 based on the results obtained from the depth sensors 130 is selected. Using one or more computer-executed algorithms, the multiple point clouds generated by the camera-sensors 110, 130 are combined. This process is done, for example, in pairs, where two point clouds that are closest to one another are combined. Points are taken from each of the two clouds and, based upon the one or more computer-executed algorithms, points of the two clouds that are calculated as being within a certain minimum spatial distance of each other are determined as coinciding points and are overlayed. In Step 530, a mesh, which is defined as a polygonal representation of an object, is created based on the combined point cloud data. The data received from the cameras 110 from the setup stage is compared with the data obtained from the cameras 110 and the depth sensors 130 from the capture stage. The matching algorithm detects the unchanged parts by comparing the camera and depth sensor data captured before the picture of the object was taken with the camera and depth sensor data captured from the object picture to thereby completely eliminate the background, which is done automatically in Step 540, in order to remove unnecessary points from the point clouds. The algorithm is supplemented by trimming depth using the preset distance from the center of the object 120. The data received from the multiple cameras 110 is matched using the received mesh in Step 550. Here, an additional evaluation of the depths received from processed data received from the cameras occurs. Synchronizing the depth data obtained from the depth sensors 130 and cameras 110 occurs as well. In step 560, the data is filtered and, in Step 570, several profiles of the data processing are created.

Processing Phase

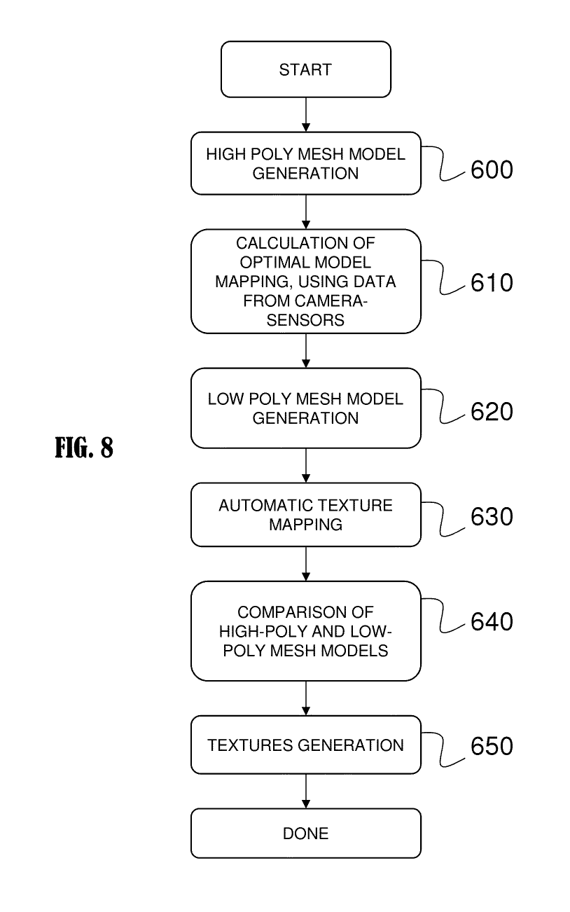

The processing phase can now begin. The process allows for the use of multiple profiles for final data processing. Each profile corresponds to the type of the output devices: “real-time”; mobile devices; home studio; and hi-end. Referring to FIG. 8, data processing starts in Step 600 by creating a High-Poly (high polygon) mesh. In Step 610, the data is read from the sensors and is matched to a mapping of optimal density. Optimizing the mesh according to the chosen processing profile in a low polygon mesh occurs in Step 620. According to an exemplary embodiment, the polygon mesh is created using a computer-executed algorithm that comprises two main steps. The first step approximates the implicit function that provides an estimate of the distance between any point in layer D and surface M. Its value can be positive or negative depending on which side of the surface the point is located. During the second step, a Poisson surface reconstruction algorithm is used while using the adaptive mesh as the accelerating structure. To construct a distance function, an oriented tangent plane is associated with each point. Each such plane is described by a certain point and a normal. The point is calculated as the center of mass of the nearest points. The normal is determined using the same set of nearest points through principal component analysis. In order to do this, a covariance matrix is created for a given set of points where the covariance matrix is symmetric and positive-semi definite. Next, an eigenvector of this matrix is found that corresponds to the minimum eigenvalue by modulus. This vector describes the direction with the minimal spread of points. This direction is interpreted as the approximate direction of the normal. The orientation of normals is taken from data existing at this point in time.

In Step 630, automatic texture mapping of the optimized mesh occurs using one or more computer-executed algorithms. A comparison of the High-Poly and Low-Poly mesh is carried out in Step 640. The textures are finally generated in Step 650. The “Normal” Map is exported from a high polygon model and the textures of a required resolution (Diffused Texture; Normal Map Texture; and Specular Texture) are exported. According to an exemplary embodiment, a computer-executed algorithm takes the mesh, camera calibration data, and high-resolution textures as input to map the textures onto the mesh. The output of such a function is a data array supplemented by textured (UV) coordinates for each model polygon as well as a texture file. The texture file is created using initial high-resolution photographs.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for creating a three-dimensional photorealistic model of a real-life object, comprising:
a set of high-resolution photographic cameras positioned about the object at multiple angles to take photographic images of the object;
a set of depth sensors positioned about the object to scan an area in which the object is disposed and to generate depth map data of the scanned area, wherein each depth sensor is aligned with one of the photographic cameras;
a computer modeling system communicatively coupled to the set of photographic cameras and the set of depth sensors; and
wherein the set of photographic cameras and the set of depth sensors transmit photographic image data and depth map data to the computer modeling system and, using at least one computer-executed algorithm, the computer modeling system processes the transmitted photographic image and depth map data and automatically creates a photorealistic three-dimensional computer model of the object.

2. The system according to claim 1, further comprising at least one light positioned about the object to provide a similar illumination to all of the photographic cameras.

3. The system according to claim 1, wherein the depth map data generated by each depth sensor is in the form of a point cloud.

4. The system according to claim 1, wherein creation of the three-dimensional computer model of the object comprises creating a polygon mesh using the at least one computer-executed algorithm.

5. The system according to claim 4, wherein creation of the three-dimensional computer model of the object comprises mapping textures obtained from the photographic image data to the polygon mesh using the at least one computer-executed algorithm.

6. A method for creating a three-dimensional photorealistic model of a real-life object, comprising:
positioning a set of high-resolution photographic cameras about the object at multiple angles to take photographic images of the object;
positioning a set of depth sensors about the object to scan an area in which the object is disposed, wherein each depth sensor is aligned with one of the photographic cameras;
communicatively coupling a computer modeling system to the set of photographic cameras and to the set of depth sensors;
capturing photographic image data of the object using the set of photographic cameras and transmitting the captured photographic image data to the computer modeling system; simultaneously with the photographic image data capture, scanning the area in which the object is disposed using the set of depth sensors and transmitting generated depth map data to the computer modeling system; and
using at least one computer-executed algorithm, processing the transmitted photographic image and depth map data and automatically creating a photorealistic three-dimensional computer model of the object with the computer modeling system.

7. The method according to claim 6, further comprising positioning at least one light about the object to provide a similar illumination to all of the photographic cameras.

8. The method according to claim 6, wherein the depth map data generated by the depth sensor is in the form of a point cloud.

9. The method according to claim 6, wherein the creating step further comprises creating a polygon mesh using the at least one computer-executed algorithm.

10. The method according to claim 9, wherein the creating step further comprises mapping textures obtained from the photographic image data to the polygon mesh using the at least one computer-executed algorithm.
